(19) United States
(12) Patent Application Publication
(10) Pub. No.: US 2017/0111738 A1
(43) Pub. Date: Apr. 20, 2017

(54) AUDIO SYSTEM HAVING MULTIPLE PERSONAL WIRELESS AUDIO RECEIVERS

(71) Applicant: Ekko Audio, LLC, North Port, FL (US)

(72) Inventors: Sean Murray, Ellenton, FL (US); Frank Elge, III, Sarasota, FL (US)

(73) Assignee: Ekko Audio, LLC, North Port, FL (US)

(21) Appl. No.: 15/293,986

(22) Filed: Oct. 14, 2016

Related U.S. Application Data
(60) Provisional application No. 62/242,577, filed on Oct. 16, 2015.

(51) Int. Cl. H04R 3/12; H04R 27/00; H04B 5/00

(52) U.S. Cl. CPC H04R 3/12; H04B 5/0037; H04R 27/00; H04W 88/02

(57) ABSTRACT

A wireless audio transmitter system includes a base transmitter unit and one or more portable receiver units. The base unit receives input from an audio source and transmits one or more corresponding signals to one or more of the portable receiver units simultaneously. Headphones or speakers may be plugged into the receiver units to enable listening to the audio signal received by the receiver unit.

### RELATED APPLICATION

This application claims priority to U.S. provisional application Ser. No. 62/242,577, filed Oct. 16, 2015.

### BACKGROUND OF THE INVENTION

The present invention generally relates to audio transmitters and receivers. More particularly, the present invention relates to an audio system comprising an audio transmitter with wireless portable receivers enabling multiple listeners to share a single sound source, wirelessly, using headphones, earbuds or speakers connected to the portable receivers.

Wireless headphones enable individual users to listen to a wireless audio signal privately, and without disturbing others in the area. Most wireless headphone systems, however, are intended for use by a single user and suffer from quality, comfort and ergonomics issues due in part to the use of lossy, non-IEEE 802.11 radio frequency transmission protocols. The use of multiple wireless headphone systems is possible, but tends to introduce channel noise, crosstalk, or other interference when these multiple transmitter/receiver systems operate in close proximity.

Many amplified loudspeaker systems are capable of reproducing sounds throughout much of the audible spectrum with a high degree of accuracy when combined with a high fidelity audio source (one that conforms closely or exactly when compared with the original audio stream). These systems, however, are often incapable of receiving wireless audio streams without the use of external, non-portable wireless transmitter/receiver systems, which often require external power sources to function (defeating the functionality of portable, amplified wireless speakers).

The number of simultaneous users of a single wireless audio or audiovisual transmitter/receiver system is often hardware-limited by the number of connected, dedicated receiver devices. Additionally, the transmitters in these transmitter/receiver systems are typically incapable of receiving audio from a wireless source (e.g. wirelessly streaming from a compatible mobile device).

Accordingly, there is a continuing need for a system that provides multiple simultaneous users with the ability to use any pair of headphones or speakers to receive high quality audio wirelessly from any source. The system should provide multiple battery-powered receiver units and a transmitter so that the multiple users can listen to the same sound source simultaneously. Additionally, the system should allow any IEEE 802.11-capable mobile device (e.g. a smartphone or tablet with specific software installed) to act as a receiver, so as to remove the hardware limitation on the number of simultaneous users. The present invention fulfills these needs, and provides other related advantages.

### SUMMARY OF THE INVENTION

The present invention resides in an audio system that provides multiple simultaneous users with the ability to use headphones, earbuds or the like and receive high quality audio wirelessly from a common audio source base unit transmitter. The base unit receives one or more audio signals and wirelessly transmits encoded digital signals corresponding to the received one or more audio signals. A plurality of portable receiver units are in wireless communication with the base unit. The portable receiver units each have power and volume controls, and are operably connectable to individual headphones or the like. The base unit transmits the one or more encoded digital signals to the plurality of portable receiver units simultaneously. The base unit may receive a plurality of distinct audio signals and transmit each audio signal, or a corresponding audio signal, to different receiver units substantially simultaneously.

The base unit may receive the one or more audio signals wirelessly. Alternatively, or additionally, the base unit may include a plurality of input ports for receiving the audio signal from at least one of a variety of wire connections to an audio source device.

A portable electronic device may wirelessly control the base unit and/or one or more of the receiver units. The portable receiver units may comprise smartphones or dedicated personal wireless receiver units.

Typically, the portable receiver units are battery powered. The portable receiver units may be coupled to the base unit for battery recharging. This may be done, for example, by inductive charging. However, the base unit and the receiver units may include magnetic contacts which detachably engage one another, which may comprise charging contacts. The base unit may include recessed wells having a configuration corresponding to at least a portion of the receiver units for removable reception of the receiver units. Moreover, the receiver units may be further configured for a recharging via USB cable when disassociated from the base unit and/or when in use as an audio receiver.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is top perspective view of a system embodying the present invention, including a base transmitter unit and a plurality of removable portable receivers;

FIG. 2 is a bottom perspective view of the base transmitter of FIG. 1;

FIG. 3 is a side elevational view of the base transmitter and receivers of the present invention;

FIG. 4 is an opposite side view of FIG. 5;

FIG. 5 is a side view of a portable receiver unit embodying the present invention;

FIG. 6 is a partially exploded view illustrating the multiple receiver units detached from the base transmitter, in accordance with the present invention;

FIG. 7 is a side perspective view of a portable receiver unit embodying the present invention and a headphone with earbuds to be plugged operably therewith;

FIG. 8 is a diagrammatic view of a base unit transmitter of the present invention transmitting one or more audio signals to portable receiver units, in accordance with the present invention;

FIG. 9 is a diagrammatic view of a portable electronic device in communication with a base unit transmitter, in accordance with the present invention;

FIG. 10 is a diagrammatic view of a portable electronic device and a portable receiver unit in communication with one another, in accordance with the present invention;

FIG. 11 is a perspective view of a dongle transmitter wirelessly communicating with the portable receiver unit, in accordance with the present invention;

FIG. 12 is a rear perspective view of the dongle of FIG. 11, illustrating wire connection ports thereof and a wire cable for coupling with an audio device, in accordance with the present invention;

FIG. 13 is a schematic diagram illustrating the logic of a transmitter embodying the present invention;

FIG. 14 is a schematic diagram illustrating the logic of a receiver embodying the present invention;

FIG. 15 is a flow chart depicting the steps of audio processing and transmission, in accordance with present invention;

FIG. 16 is a flow chart depicting the steps taken in pairing the device, in accordance with the present invention;

FIG. 17 is a schematic diagram illustrating electronic communication between devices used in accordance with the present invention;

FIG. 18 is another schematic diagram illustrating electronic coupling of the system of the present invention with a mobile device or computer using a software application, in accordance with the present invention;

FIG. 19 is a flow chart illustrating the steps taken in accordance with the mobile application used in accordance with the present invention;

FIG. 20 is a schematic diagram illustrating electronic communication between electronic devices, in accordance with the present invention;

FIG. 21 is a flow chart depicting the steps taken in connection with a pager process, in accordance with the present invention; and

FIG. 22 is a flow chart depicting the steps taken in a receiving unit charge process, in accordance with the present invention.

### DETAILED DESCRIPTION OF THE PREFERRED EMBODIMENTS

As shown in the accompanying drawings, for purposes of illustration, the present invention resides in an audio system which enables multiple users to share a single audio source wirelessly using their own headphones, earbuds, speakers, or other audio jack enabled device. The system of the present invention provides multiple users the ability to use any pair of headphones or personal speakers to receive high quality audio from any source via a portable audio receiver which is wirelessly coupled to an audio transmitter, which is the single source of one or more audio signals for the multiple portable audio receivers.

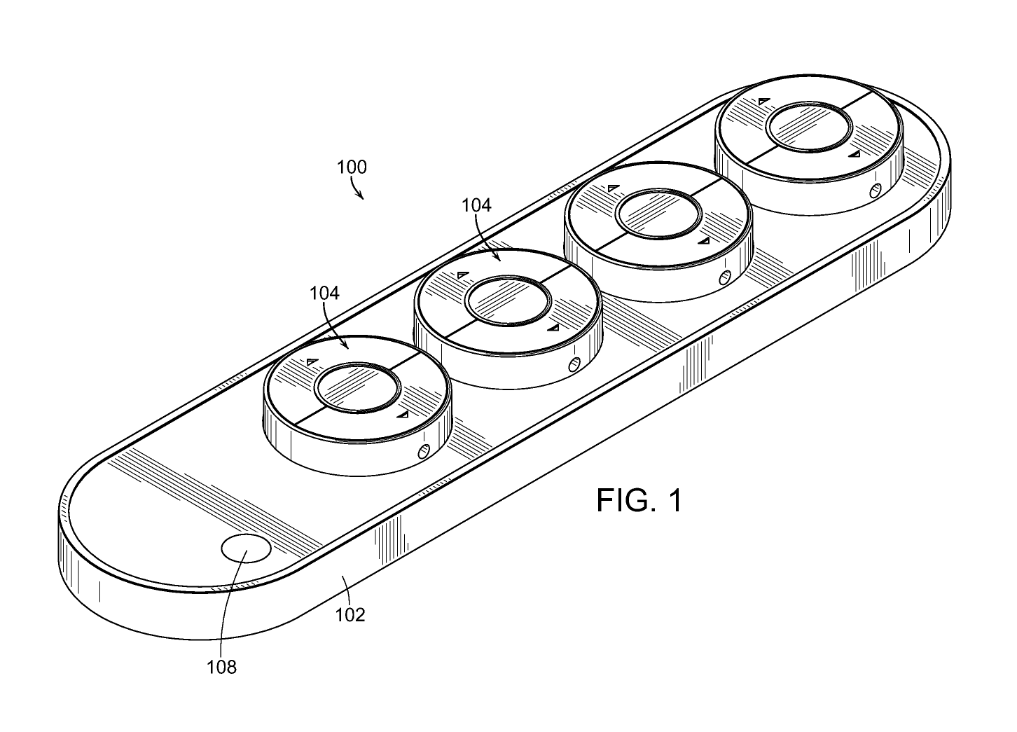

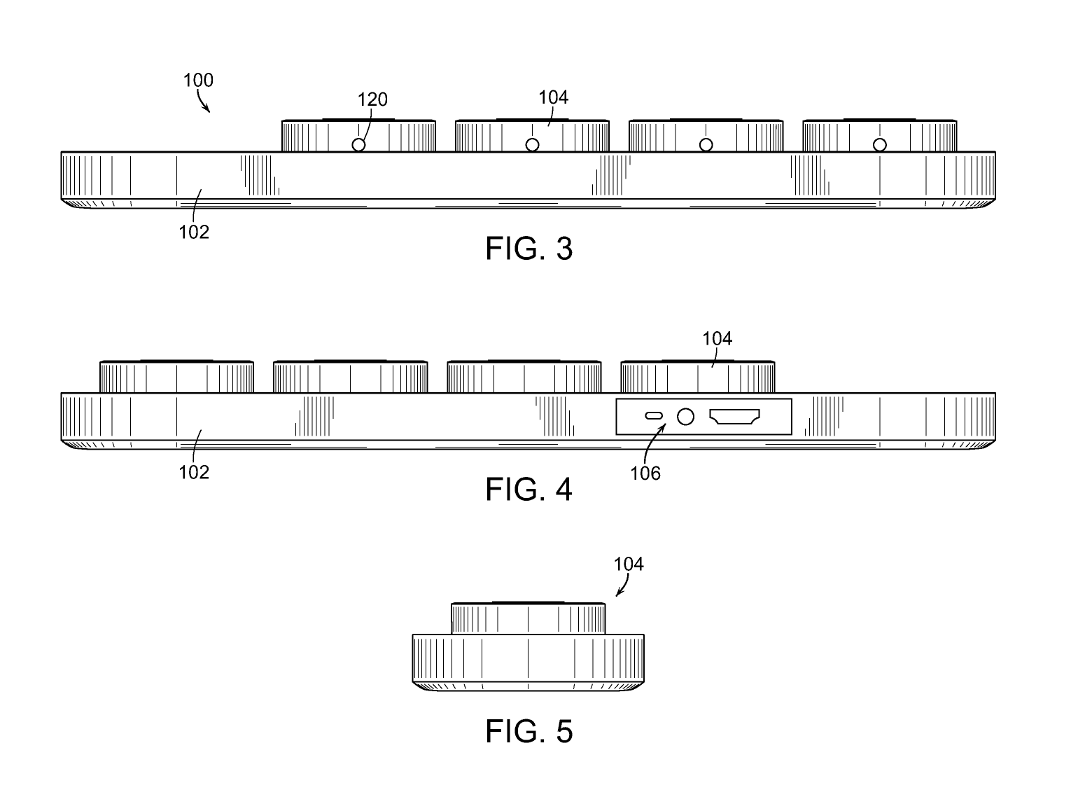

With reference now to FIGS. 1-7, a particularly preferred embodiment of the system 100 of the present invention is shown comprised of a base transmitter unit 102 and a plurality of personal portable receiver units 104. The base transmitter unit 102 receives an audio signal and transmits it to one or more portable receiver units 104 that are headphone jack enabled. It is contemplated by the present invention that the user may plug in any pair of headphones or speakers to listen to the audio signal transmitted from the base transmitter unit 102 to the one or more portable receiver units 104.

The base transmitter unit 102 may receive audio wirelessly or directly through a wired connection from an audio source including, but not limited to, a television, a digital media player, an online audio streaming service, a computer, a tablet, a smartphone or the like. The base transmitter unit 102 may receive the audio signal via a wired input or via an integrated wireless receiver. The base transmitter unit 102 may transmit and receive using any radio frequency, Bluetooth, infrared, or any other well known means of transmitting and receiving audio signals. The transmission and receipt of audio signals may be made, for example, via IEEE 802.11 radio frequency.

The base transmitter unit 102 may be network addressable. In server mode, it may broadcast through LAN/802.11 or the like. It may broadcast the audio signal to a receiver over LAN. The base transmitter station 102 may broadcast to any 802.11 or LAN enabled device, such as a smart phone with mobile application, or computer with downloaded application. The base transmitter station 102 may have software and run software applications, such as an operating system, and connect to the Internet and act as a local streaming server. The base station 102 can receive commands remotely via LAN or locally via 802.11 or Bluetooth or the like.

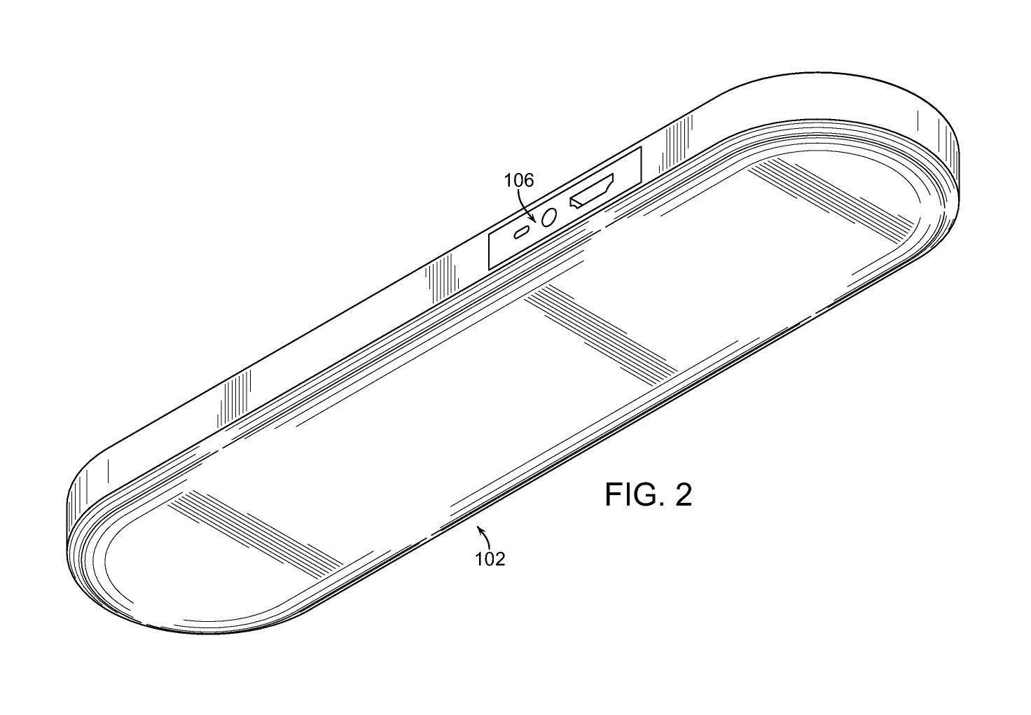

With reference now to FIGS. 2 and 4, the base unit 102 typically has a plurality of input and/or output ports 106, including HDMI, USB, and other audio and/or video inputs and outputs for connecting the base unit 102 to the source of the audio or video signal, including a television, receiver, computerized device having the Internet, etc. Such ports 106 may also include a power port for attaching a power cord or the like. Of course, a power cord could also be integrally formed with the unit 102 for providing power thereto.

The base station 102 may be directly wired to a power source, such as an alternating current wall outlet, a power transformer, or the like. The base station 102 may also be battery powered, such as by removable and disposable batteries, rechargeable batteries, or the like. In the case that the base unit 102 includes a rechargeable battery, the base unit 102 may be periodically plugged in to recharge the batteries, and then the base unit 102 can be placed or mounted in a variety of locations.

The transmitter unit 102 may also include buttons 108 for manually powering the unit 102, altering the volume and other controls of the base transmitter unit 102 and any corresponding visual indicators, such as LEDs or the like to visually indicate the state of the base transmitter unit 102.

The base station 102 may securely transmit wirelessly. It may have a mobile application control, which controls volume, EQ, security, network settings, parental controls and the like. This may be controlled, for example, by a mobile device such as a tablet, computer, cell phone, or the like. It is also contemplated by the present invention that the portable receiver units 104 could control various aspects and functions of the base unit 102. For example, the base unit 102 may be volume limiting. It is also contemplated by the present invention that the base unit 102 synchronize video and audio, and do so with adjustable delay function.

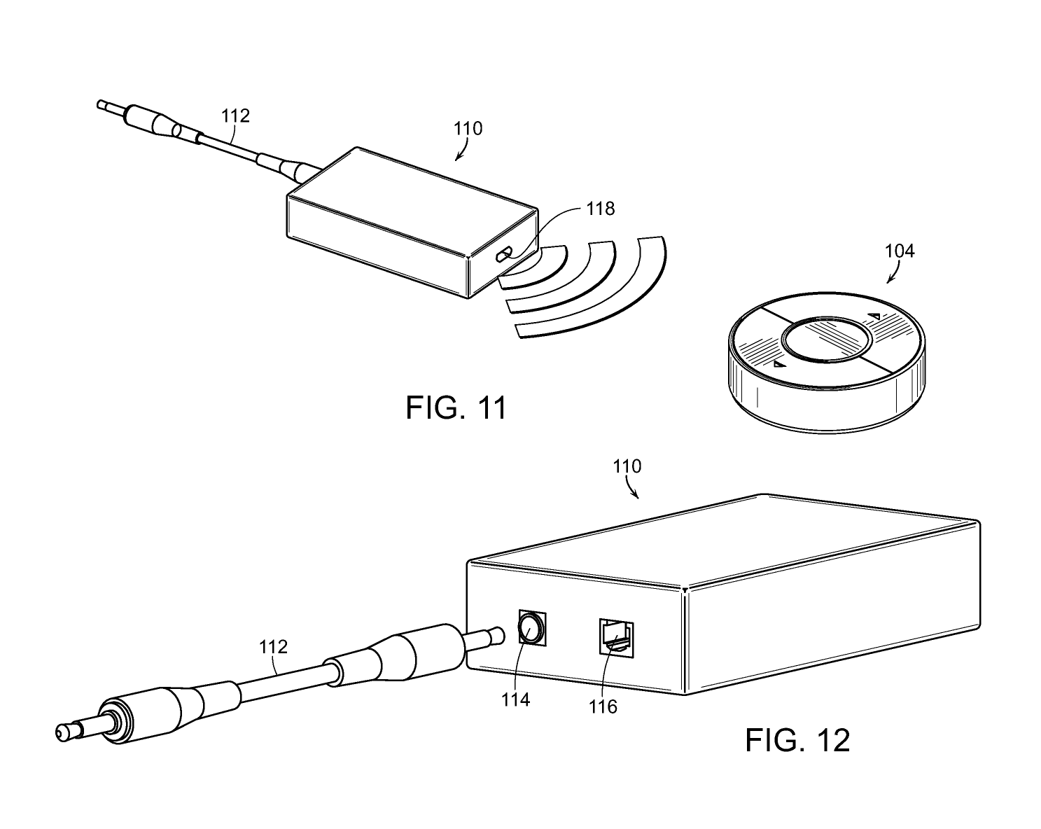

With reference now to FIGS. 11 and 12, the base station 102 may be augmented with a separate “dongle” transmitter 110, which may be plugged into a compatible source such as a TV or digital media player. The dongle may transmit wirelessly from the source to the base station 102, or directly to the portable receiver units 104, as illustrated in FIG. 11, enabling completely wire-free operation. The transmitter dongle 110 could be capable of replacing the base station 102, such as in applications where only transmission is required of the dongle or base unit, and not recharging of the portable receiver units 104, as will be discussed more fully herein. Although the dongle transmitter 110 could receive signals wirelessly, more typically it includes input ports for receiving audio signals directly from a wired cable 112 or the like. Such input ports could comprise an AUX/3.5 mm female input port 114, a TOSLINK/digital optical female input port 116, an USB/power input port 118 and the like so as to receive the necessary power and receive audio signals from various cable and wired connections from the various audio sources, including those indicated above.

The portable receiver units 104 may transmit and receive using radio frequency, IEEE 802.11, Bluetooth, and infrared, and receive and transmit audio as well as video signals in some cases. They may receive mono or stereo audio signals, as determined by the configuration.

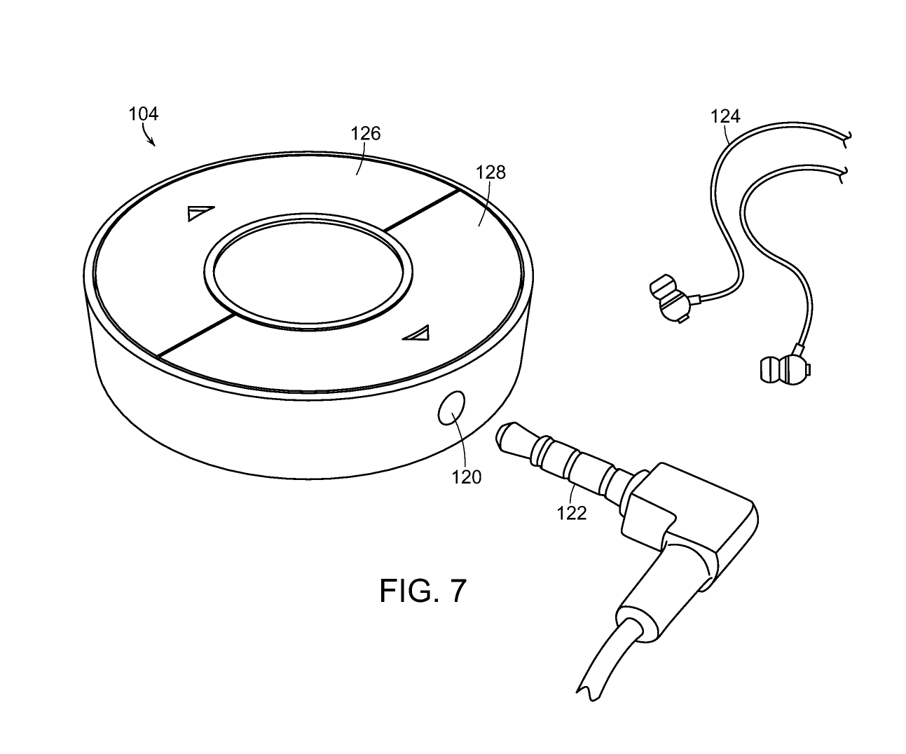

As shown in FIG. 7, the portable receivers 104 have a jack 120, such as a 3.5 mm jack, to plug in headphones and/or speakers. More particularly, the jack port 112 is adapted to receive jack or plug 122 of a pair of headphones 124 for personal use by the user of the portable receiver unit 104. The portable receiver 104 may auto-sense when the stereo plug 122 is inserted to power on the unit 104, such as auto-sensing a 3.5 mm TRS jack output. The portable receiver units 104 may also have I/O USB for power and charging, and signal receiving/transmission.

The portable receiver units 104 may have manual buttons 126 and 128 for power, controlling volume, tracking next/previous audio file, and the like. These may also be used for selecting channels. The portable receiver units 104 may also include visual indicators, such as LED lights, for locator/pager functionality, alarms, “page mode”, etc. The device lights may be programmable, and the colors may be selected by the user during initial setup. These manual buttons may be capacitive or resistive touch enabled, or any other kind of button.

The portable receivers 104 may send data such as battery health, charge, signal quality, volume and usage history, etc. to the base station 102. The portable receiver units 104 can also pair with and receive from other Wi-Fi enabled devices. They may be network addressable, and the receivers may be assigned IP automatically based on configuration.

The portable receiver units 104 may have two-way communication with a microphone, such as a microphone-enabled headphone. It is contemplated that the portable receiver unit 104 will have a microphone mute functionality.

The receivers may be comprised of a sufficiently durable material or have a particular configuration and design so as to render them resistant to impact forces they may encounter while being moved by the user. As such, the receivers may contain rubber spacers that isolate impact forces between the plastic housing and the internal components so as to protect the internal electronic components.

Typically, the portable receiver units 104 include rechargeable batteries. The receiver units 104 can be individually charged, such as by plugging into a wired power source, such as a five-volt USB or the like. In a particularly preferred embodiment, the receiver units 104 are recharged by the base unit 102, either by induction or contact point charging. However, it is also contemplated that the receiver units 104 have removable and disposable batteries therein.

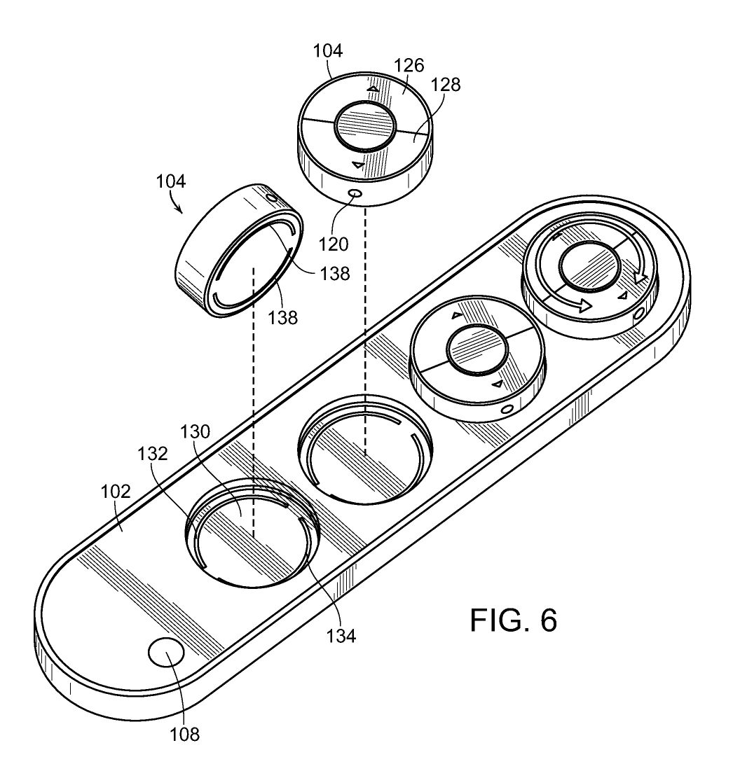

With reference now to FIGS. 1-6, the receiver units 104 may be removably attached to the base unit 102. As illustrated in FIG. 6, the base unit 102 may include attachment point recesses or wells 130 for receiving the receiver units 104 therein. The recessed wells 130 of the base unit 102 have a configuration corresponding to at least a portion of the receiver units 104 for removable reception of the receiver units therein. In a particularly preferred embodiment, as illustrated, the portable receiver units 104 are generally circular in design and approximately the width of a casino chip. The corresponding well 130 would be circular as well, and of a slightly greater diameter so as to receive the portable receiver 104 therein. When the receiver units 104 are disposed within the wells 130, the rechargeable batteries of the receiver units 104 may be recharged, such as by inductive charging by being disposed adjacent to an inductive charger (not shown) within the base unit 102.

In one embodiment, as illustrated in FIG. 6, the base station 102 has built-in magnets 132 and 134 which correspond to magnets 136 and 138 within or on the receiver units. This arrangement serves several purposes. The base station 102 built-in magnets 132 and 134 are positioned in such a way so as to properly orient receivers, to eliminate the possibility of incorrect insertion. The magnets 132 and 134 of the base unit 102 are of opposite polarity, and correspond with magnets 136 and 138 also of opposite polarity in the receiver unit 104. Thus, as the receiver unit 104 is placed within the well 130, if the magnets of the recess 130 and of the receiver unit 104 are aligned of similar polarity, such as a north magnet being disposed above and onto a corresponding north magnet, which will also result in the opposite polar magnets, such as south pole and south pole magnets being placed on top of one another, the receiver unit 104 will automatically rotate, as shown in the directional arrow of FIG. 6, until the magnets of opposite polarity are aligned with one another. For example, magnet 136 of receiver unit 104 may be of a given polarity and the magnet 132 within the recessed well 130 may be of an opposite polarity, such that the magnets will attract one another, with a similar situation being the case with magnets 134 and 138. Thus, the receiver unit 104 will become properly positioned and aligned within the recessed well 130. This may be important, for example, if charging contact points are utilized to recharge the receiver unit 104, which contact points could actually comprise the magnets themselves.

Moreover, due to the strong magnetic connection between the base 102 and the receivers 104, the receivers 104 are not prone to inadvertent slippage out of their recesses or wells 110. Also, the strong magnetic connection between the base 102 and the receivers 104 allow the docked receivers 104 to be wall mounted or even mounted upside down and still retain connection with the base unit 102.

Use of the magnets 136 and 138 within the receiver units 104 also allow the receiver units 104 to be removably secured to any ferromagnetic or ferrimagnetic surface. For example, a magnetic clip (not shown) may allow the receiver unit 104 to be secured onto clothing or the like. It is also contemplated by the present invention that the receiver units 104 have permanent adhesive mounting or suction-cup mounting for multi-room setup.

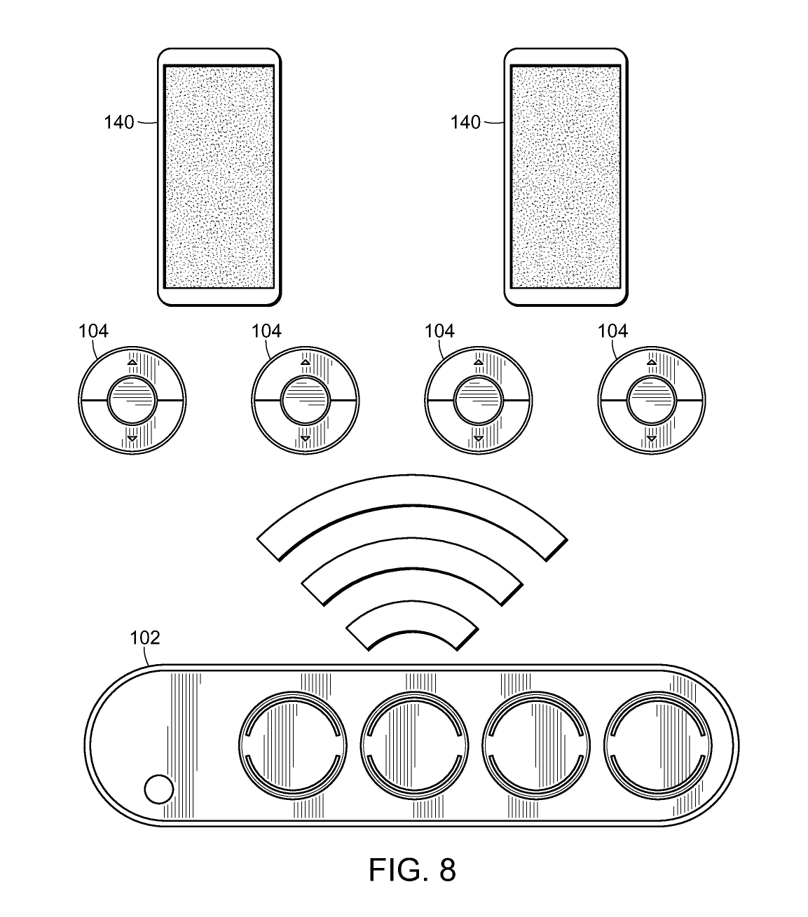

With reference to FIG. 8, the base unit 102 is shown transmitting one or more audio signals to a plurality of personal portable receiver units 104. As described above, the receiver units 104 are headphone enabled so that a user receives the desired audio signal from the base unit 102 and can listen to the audio signal through his or her headphones in a wireless manner. It will be understood that the wireless audio receiver units 104 may receive the same encoded wireless digital audio signal from the base unit 102. Thus, the receiver units 104 receive the same audio signal from a common source, through the base unit 102. In other instances, the base station has the ability to receive audio signals with more than two channels, which can be processed by circuitry in the base unit 102 and transmitted separately to the receiver units 104. The base station may also have the ability to receive multiple audio inputs wirelessly or via wired inputs, and transmit each individual audio signal to a different receiver unit 104. Thus, different users utilizing the receiver units 104 may receive different audio signals from different audio sources through the base unit 102 simultaneously.

With continuing reference to FIG. 8, it is also contemplated by the present invention that Wi-Fi enabled devices such as smartphones, can act as portable receiver units for the signals transmitted from the base station 102. The portable electronic device 140, such as a smartphone, may have an application downloaded thereto to receive audio signals from the base unit 102. These portable electronic devices 140 will be headphone enabled. Moreover, such portable electronic devices 140 have a display screen which may be utilized to receive audio signals which are synchronized with video. It will also be understood that the audio signals transmitted from the base unit 102 may be synchronized with a common video source, such as a television or the like.

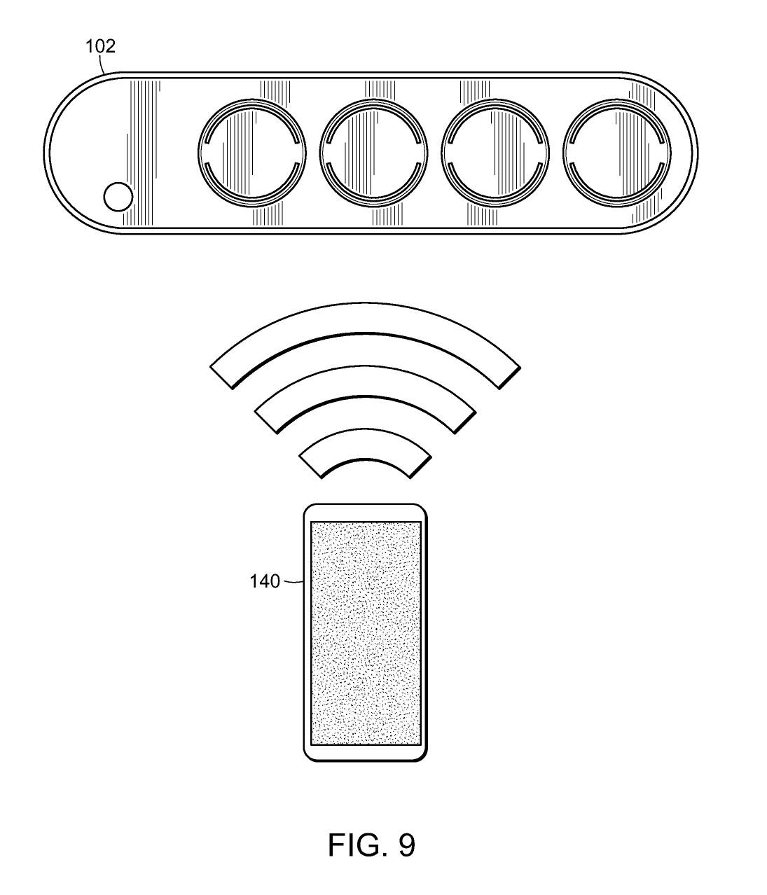

With reference now to FIG. 9, it is also contemplated by the present invention that the smartphone 140 or other portable personal electronic device could transmit to the base station 102. This could be, for example, transmitting an audio signal, which will then be transmitted to the personal audio receiver units 104. The present invention may include smartphone application functionality for base station control, volume limiting, usage and volume logging, volume, normalizing, on/off, individual receiver unit 104 battery information and the ability to turn the smartphone into a portable sound receiver.

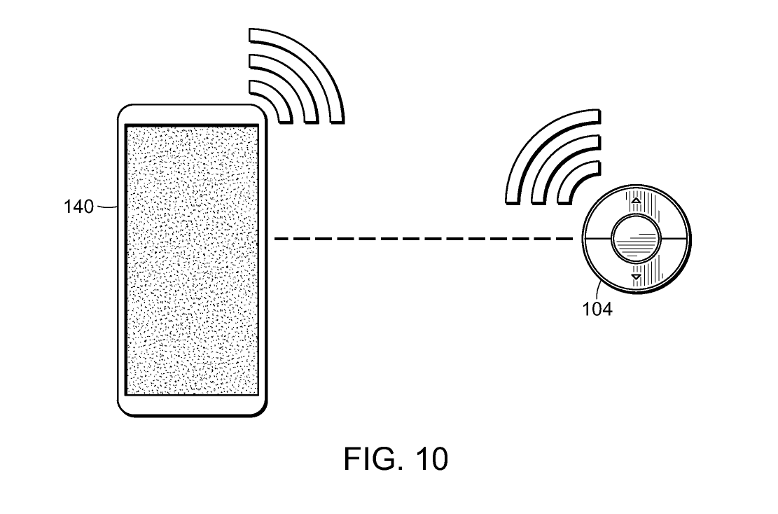

With reference now to FIG. 10, the present invention contemplates the ability of the portable receiving units 104 to communicate directly with the personal electronic device or smartphone 140. A proximity sensing mechanism between the smartphone application and the personal receiver unit 104 could be employed by any method, such as radio frequency, Wi-Fi, Bluetooth, or the like. Two-way communication functionality of the receiver units 104 with the computer software application, such as on the personal electronic device 140, could sort audio from multiple users for use in popular conference software. The base station 102 may also have the ability to synchronize video signals with audio to account for latency introduced in the streaming process which could be controlled, for example, by a smartphone application or the like. The base station 102 could receive the audio and/or video signals via wired connection or wirelessly, such as through Bluetooth or Wi-Fi or the like. Regardless, the system 100 of the present invention enables listeners to use their own personal earbuds or headphones to listen to a source of audio transmitted through the base unit transmitter 102 or corresponding router.

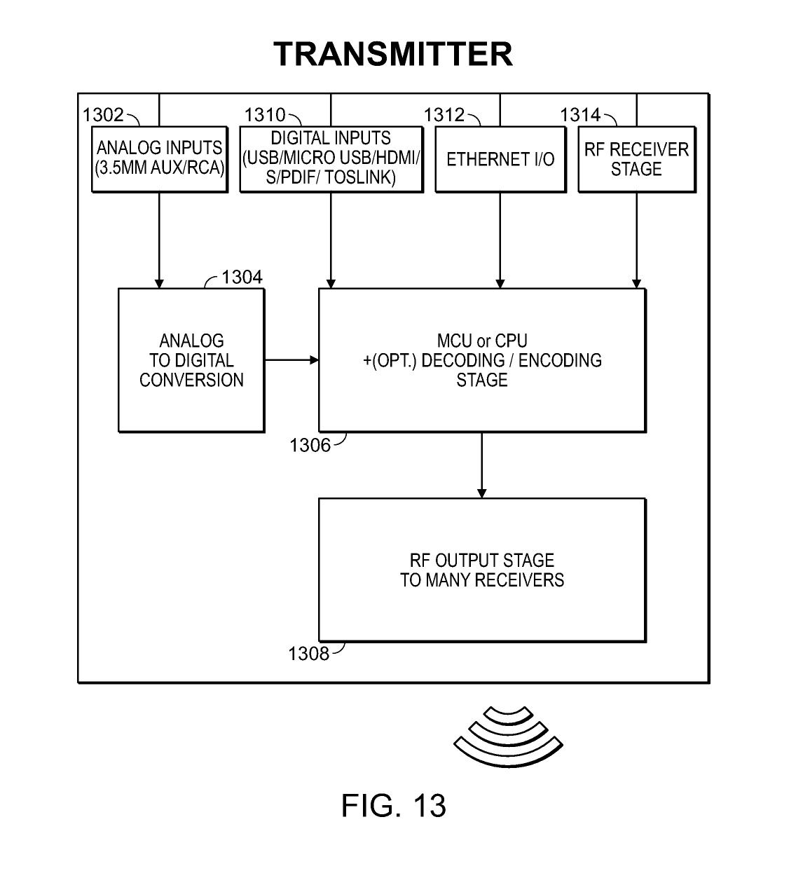

With reference now to FIG. 13, a schematic is shown illustrating the logic of the transmitter 102 of the present invention. The transmitter 102 may receive a variety of inputs. When receiving an analog input 1302, such as from an RCA cable, 3.5 mm TRS/AUX or the like, the analog signal is converted to digital 1304. The converted digital signal is then decoded and/or encoded by an MCU or CPU 1306, before the signal is output, such as by radio frequency wireless signal, to the one or more receiver units 104 in step 1308.

Other inputs, such as digital inputs received from USB, micro-USB, HDMI, Toslink, S/PDIF, or the like 1310, Ethernet or IO 1312, and RF receiver stage 1314 signals which are digital are directly encoded/decoded by MCU or CPU 1306.

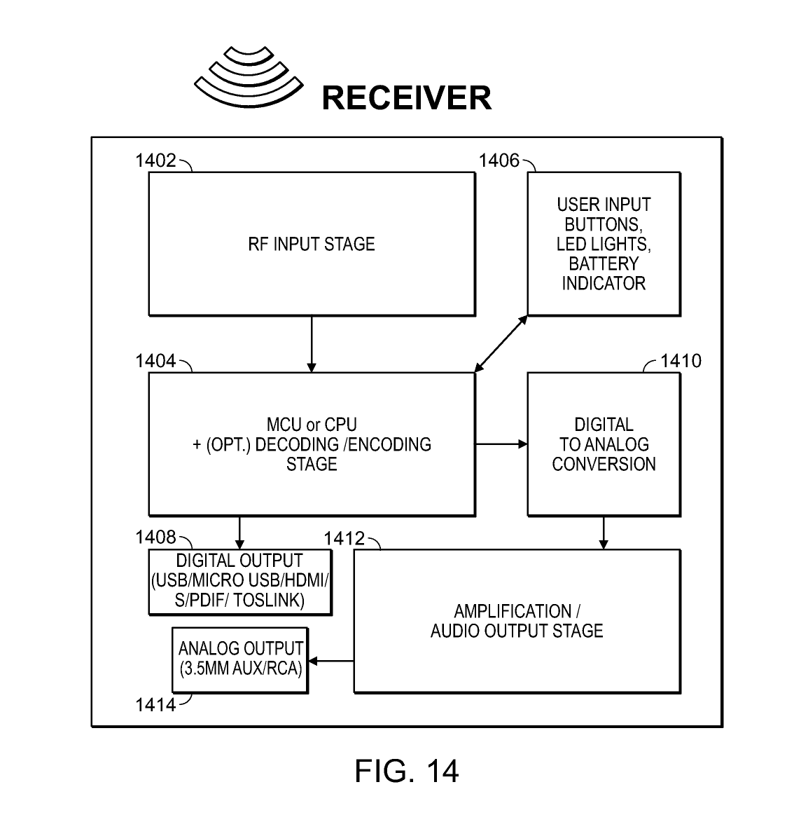

With reference now to FIG. 14, the wireless radio frequency signal is received at the input stage 1402 where the signal is encoded and/or decoded by an MCU or CPU 1404. The user input buttons, LED lights, battery indicator and the like are all controlled by and monitored by the MCU or CPU 1404. For a digital output, the signal after being encoded or decoded is sent to the digital output, such as the USB, micro-USB, HDMI, S/PDIF, Toslink, or the like 1408. However, if required, the digital signal is converted to analog 1410, and sent to an amplifier/audio output stage 1412, where the analog signal is then output 1414, such as by 3.5 mm aux, RCA, or the like.

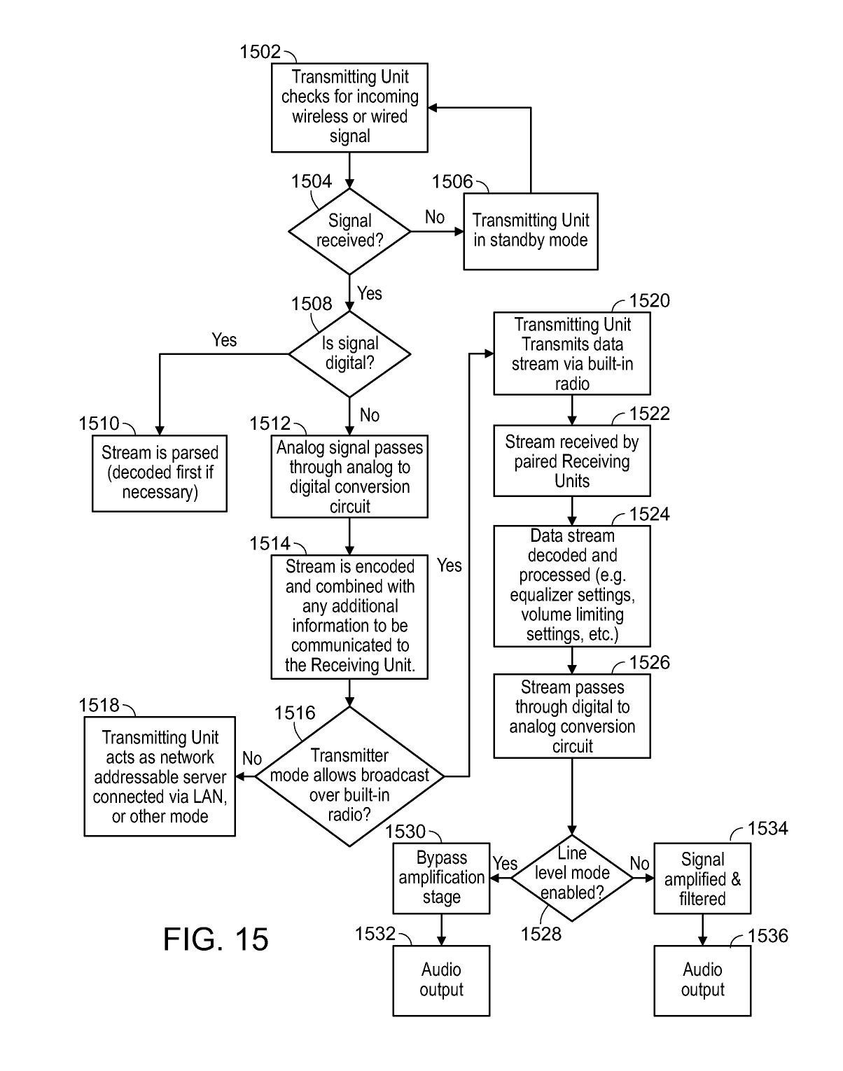

With reference now to FIG. 15, the steps taken in accordance with the audio processing and transmission of the signal are shown. Based on user input or automatically via software or firmware programming, the transmitting base unit 102 checks for incoming wireless or wired signals 1502. It is determined whether a signal is received 1504. If not, the transmitting unit 102 is placed in standby mode 1506. However, if a signal is received the system determines whether the signal is digital 1508. If the signal is digital, then the digital stream is parsed, that is decoded first, if necessary 1510. However, if the signal is not digital, the analog signal passes through an analog to digital conversion circuit 1512. The digital stream is then encoded and combined with any additional information to be communicated to the receiving unit 1514.

It is then determined whether the transmitter mode allows the broadcast or a built-in radio 1516. If not, the transmitting unit acts as a network addressable server, connected via LAN or other mode 1518. However, if the transmitter mode allows the broadcast over built-in radio, the transmitter unit transmits data stream via built-in radio 1520. The stream is received by paired receiving units 1522, where the data stream is decoded and processed 1524, such as equalizer settings, volume limiting settings, etc. The digital stream then passes through a digital-to-analog conversion circuit 1526, if necessary.

It is then determined whether the line level mode is enabled 1528. Line level mode enabled or disabled depends upon the use with the headphones or speakers. Most headphones will require amplification. Most speaker systems will include amplification and will not require amplification through the receiving unit 104. If the line level mode is enabled, the signal passes through a bypass amplification stage 1530 and to the audio output 1532. If not, the signal is amplified and filtered 1534 before being sent to the audio output 1536.

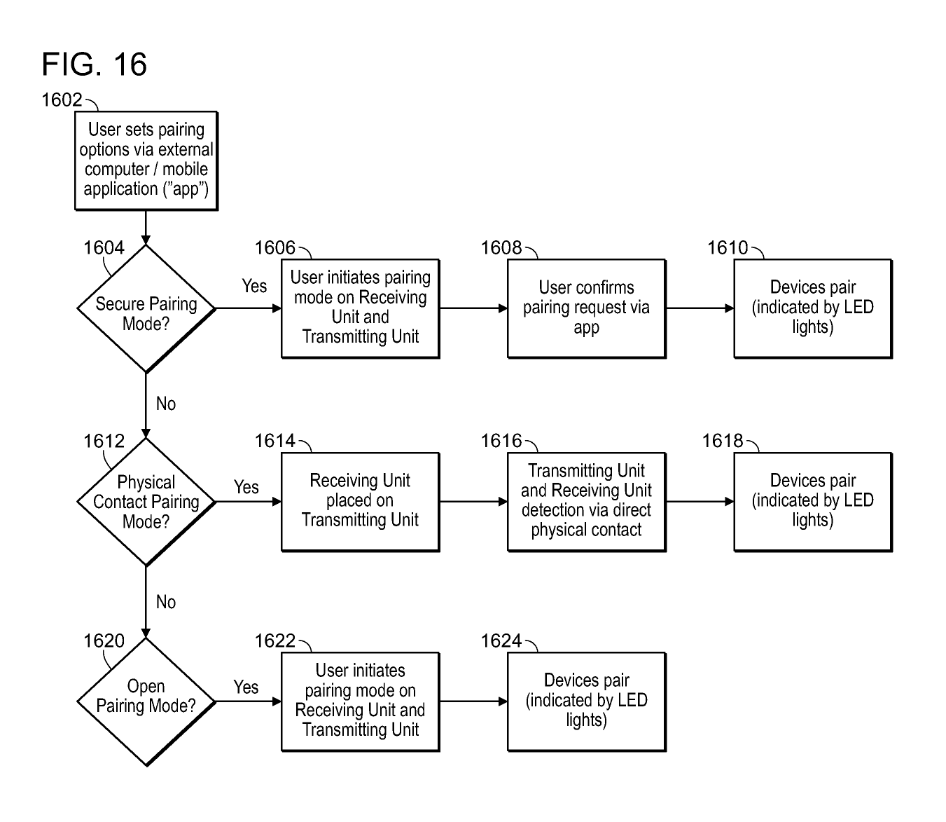

With reference now to FIG. 16, the process for device pairing is shown. The user may set the pairing options via external computer/mobile application 1602. It is determined whether secure pairing mode is enabled 1604. If so, the user initiates pairing mode on receiving unit and transmitting unit 1606. The pairing mode may be initiated by the user input via software application or manual button pressing on transmitting unit and/or receiving unit. The user confirms the pairing request via software application 1608. The device is then paired, as indicated by illuminated LED lights or the like 1610.

If there is no secure pairing mode, then it is determined whether there is a physical contact pairing mode 1612. If so, the receiving unit is placed on the transmitting unit 1614. The transmitting unit and receiving unit detect one another via direct physical contact 1616. The method for transmitting unit recognizing receiving unit upon contact, may include, but is not limited to, NFC, charge connection or pulsed charge connection code in which specific sequence of electric pulse is sent from transmitting unit to receiving unit to validate that the two devices are attempting to pair are actually in direct physical contact with each other, or some other kind of proximity detection method. The devices then pair, as indicated by the illuminated LED lights 1618.

If there is no physical contact pairing mode, then it is determined whether there is open pairing mode 1620. If so, the user initiates pairing mode on the receiving unit and transmitting unit 1622, which may be initiated by the user by input via software application or manual button pressing on the transmitting unit and/or the receiving unit. The devices are paired, which may be indicated by the flashing or illumination of LED lights or the like 1624.

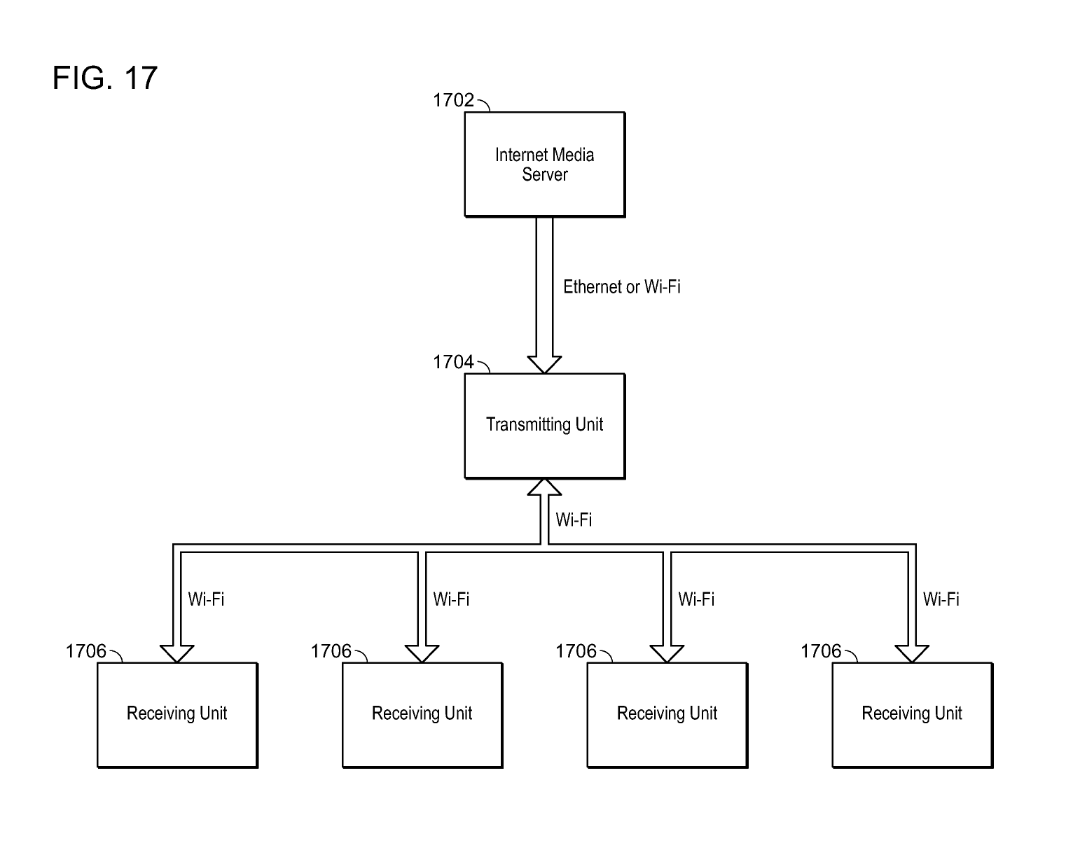

With reference now to FIG. 17, a schematic diagram illustrates the local and network broadcast mode, as used by the present invention. An Internet media server 1702, including, but not limited to, Internet media streaming services and web servers, may be in Ethernet or Wi-Fi electronic communication with the transmitting unit 1704. The transmitting base unit may communicate directly with the receiving units 1706 using Wi-Fi and/or built-in radio.

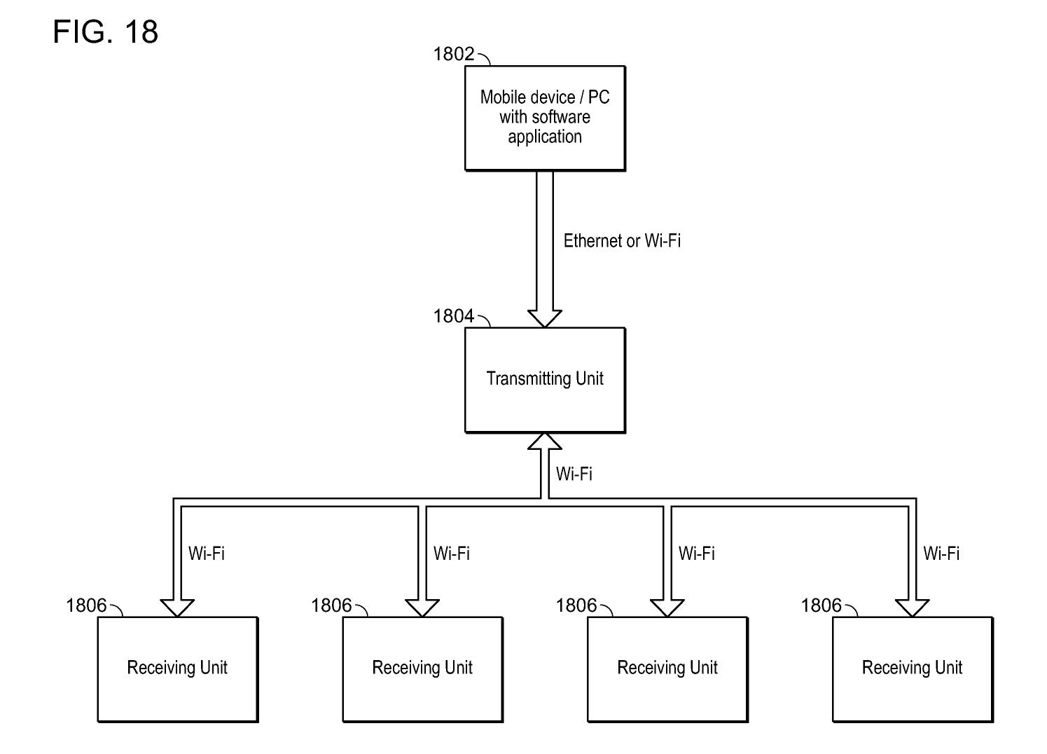

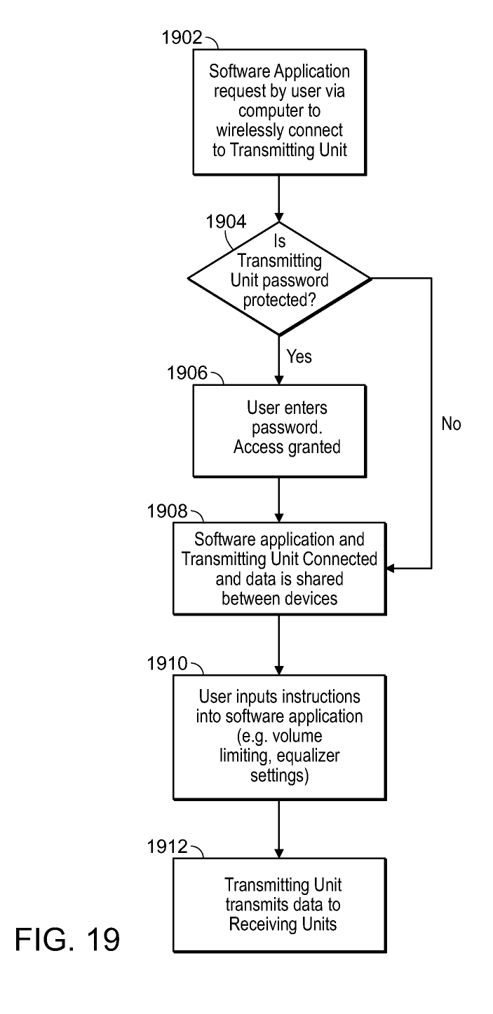

With reference now to FIG. 18, the local broadcast mode is schematically shown. A mobile device or personal computer or the like with the software application 1802 is in wireless communication with the transmitting unit 1804. This method may include, but is not limited to, radio frequency, Wi-Fi, Bluetooth, IR, etc. The transmitting unit communicates directly with the receiving units 1806 using built-in radio, and Wi-Fi signals.

With reference now to FIG. 19, the process for mobile application is shown. The software application request by the user via computer (e.g. PC, smart phone) to wirelessly connect to the transmitting unit 1902. It is determined whether the transmitting unit is password protected 1904. If so, the user enters the password and access is granted 1906. If not, or after access is granted by entering the password, the software application and transmitting unit are connected and data is shared between the devices 1908. The data may include, but is not limited to, telemetry, battery information, volume settings, equalizer settings, usage history, device status (on/off/standby), network settings, security settings, parental controls, notification settings and control of transmitting unit software applications.

The user inputs the instructions into the software application 1910, which may include volume limiting, equalizer settings, etc. The transmitter unit then transmits the data to the receiving unit 1912.

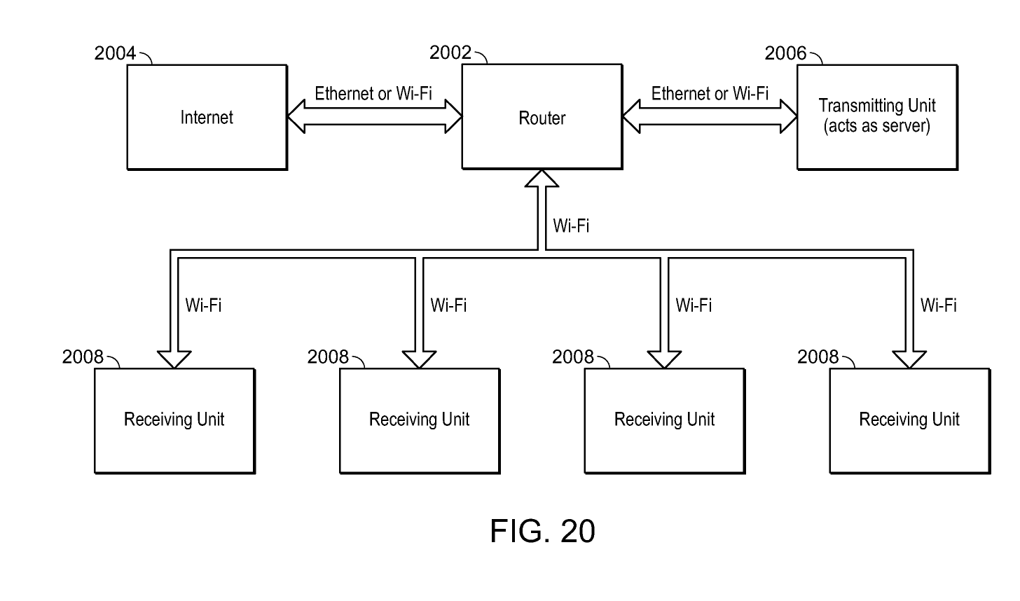

With reference now to FIG. 20, a schematic is shown where the system is in network only broadcast mode. A router or LAN/network switch 2002 receives signals and data from the Internet 2004. This Internet connection is shown, but it should be understood as being optional.

The transmitting unit acts as a server 2006 and communicates with the router 2002. The transmitting unit communicates with the receiving units 2008 via external network switching/router networking, such as by the illustrated Wi-Fi wireless signals.

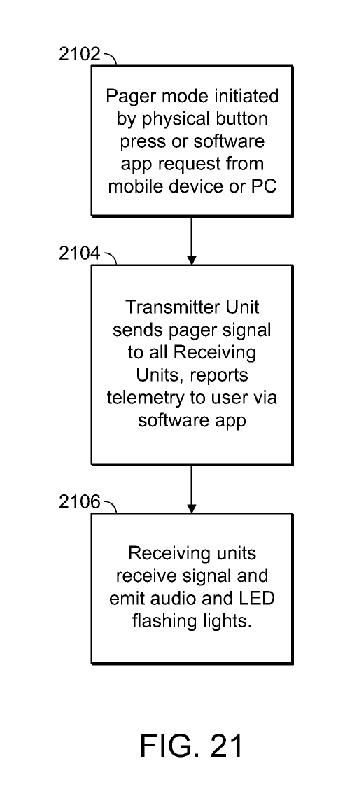

With reference now to FIG. 21, steps taken in accordance with the pager process of the present invention is shown. The pager mode is initiated by physical button press or software application requests from a mobile device or other computer 2102. The transmitter base unit 102 sends the pager signal to all receiving units 104, and reports telemetry to user via the software application 2104. The receiving units 104 receive the signal in a mid-audio and/or LED flashing lights 2106. If the pager functionality is enabled on the receiver device, the receiver will reserve a certain amount of its battery power for this function.

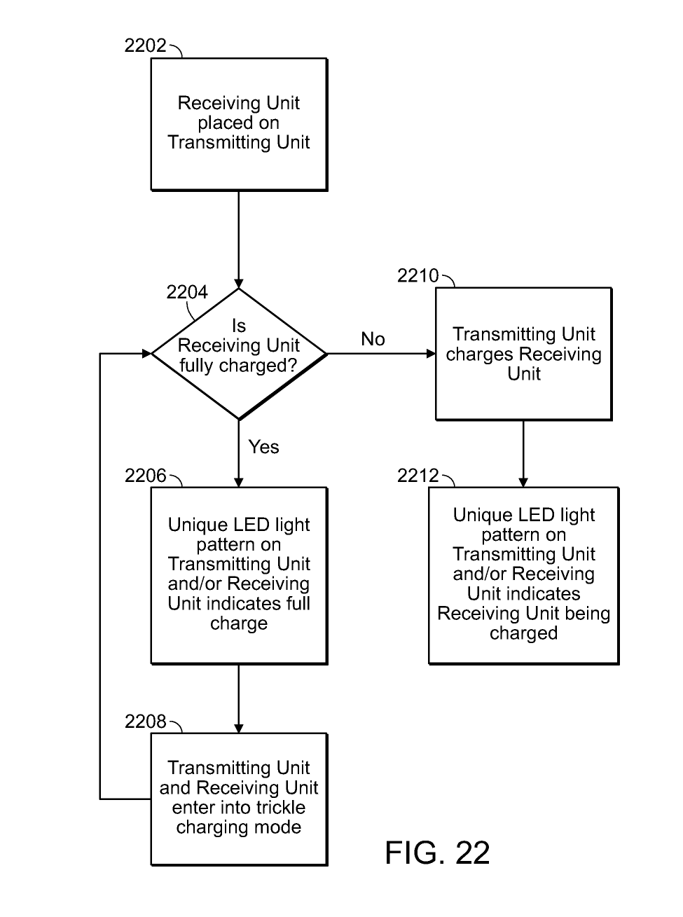

With reference now to FIG. 22, the receiving unit 104 charging process, in accordance with one embodiment of the present invention, is shown. The receiving unit 104 is placed on the transmitting base unit 2202, as illustrated and described above with respect to FIGS. 1-6. It is first determined whether the receiving unit 104 is fully charged 2204. If so, a unique LED light pattern on the transmitting unit and/or receiving unit indicates full charge 2206. The transmitting unit and receiving unit enter into trickle charging mode 2208 to ensure that the receiving unit is fully charged.

If the receiving unit is not fully charged, the transmitting unit charges the receiving unit 2210. A unique LED light pattern on the transmitting unit and/or receiving unit indicates that the receiving unit is being charged 2212, until it is fully charged.

Although several embodiments have been described in detail for purposes of illustration, various modifications may be made without departing from the scope and spirit of the invention. Accordingly, the invention is not to be limited, except as by the appended claims.

What is claimed is:

1. An audio system, comprising:
a base unit that receives one or more audio signals and wirelessly transmits encoded digital signals corresponding to the received one or more audio signals;
a plurality of portable receiver units in wireless communication with the base unit, the portable receiver units each having power and volume controls and operably connectable to individual headphones;
wherein the base unit transmits the one or more encoded digital signals to the plurality of portable receiver units simultaneously.

2. The system of claim 1, wherein the portable receiver units are battery powered.

3. The system of claim 2, wherein the portable receiver units comprise smartphones.

4. The system of claim 2, wherein the portable receiver units are coupled to the base unit for battery recharging.

5. The system of claim 4, wherein the base unit includes recessed wells having a configuration corresponding to at least a portion of the receiver units for removable reception of the receiver units.

6. The system of claim 4, wherein the receiver units are recharged by inductive charging.

7. The system of claim 4, wherein the base unit and the receiver units include magnetic contacts which detachably engage one another.

8. The system of claim 7, wherein the magnetic contacts comprise charging contacts.

9. The system of claim 1, wherein the base unit receives the at least one audio signal wirelessly.

10. The system of claim 1, wherein the base unit includes a plurality of input ports for receiving the audio signal from at least one of a variety of wire connections to an audio source device.

11. The system of claim 1, wherein the base unit receives a plurality of distinct audio signals and transmits each audio signal to different receiver units substantially simultaneously.

12. The system of claim 1, including a portable electronic device that wirelessly controls the base unit and/or one or more receiver units.

13. An audio system, comprising:
a base unit that receives one or more audio signals and wirelessly transmits encoded digital signals corresponding to the received one or more audio signals;
a plurality of battery powered portable receiver units in wireless communication with the base unit, the portable receiver units each having power and volume controls and operably connectable to individual headphones;
wherein the portable receiver units are coupled to the base unit for battery recharging; and
wherein the base unit receives a plurality of distinct audio signals and transmits each corresponding encoded digital audio signal to different portable receiver units substantially simultaneously.

14. The system of claim 13, wherein the base unit includes recessed wells having a configuration corresponding to at least a portion of the receiver units for removable reception of the receiver units.

15. The system of claim 13, wherein one or more of the receiver units are recharged by inductive charging.

16. The system of claim 13, wherein the base unit and the receiver units include magnetic contacts which detachably engage one another.

17. The system of claim 16, wherein the magnetic contacts comprise charging contacts.

18. The system of claim 13, wherein the base unit receives at least one audio signal wirelessly.

19. The system of claim 13, wherein the base unit includes a plurality of input ports for receiving the audio signal from at least one of a variety of wire connections to an audio source device.

20. The system of claim 13, including a portable electronic device that wirelessly controls the base unit and/or one or more receiver units.

21. The system of claim 13, wherein one or more of the receiver units are recharged via a USB connection.
